(19) United States
(12) Patent Application Publication
(10) Pub. No.: US 2005/0238864 A1
(43) Pub. Date: Oct. 27, 2005

(54) Filled fiber reinforced thermoplastic composite

(76) Inventors: Andrew S. D'Souza, Little Canada, MN (US); Brian C. Eastin, Woodbury, MN (US); Ronald J. Israelson, Lake Elmo, MN (US)

Correspondence Address: 3M INNOVATIVE PROPERTIES COMPANY, PO BOX 33427, ST. PAUL, MN, 55133-3427, US

(21) Appl. No.: 11/086,078

(22) Filed: Mar. 22, 2005

Related U.S. Application Data
(60) Provisional application No. 60/555,215, filed on Mar. 22, 2004.

(51) Int. Cl. B32B 27/04; B32B 27/20

(52) U.S. Cl. 428/292.1; 428/297.4; 428/299.1; 428/299.4; 428/313.3; 428/313.9

(57) ABSTRACT

Fiber-reinforced thermoplastic composites containing hollow bubbles provide surprisingly low density and retention of robust physical properties.

### PRIORITY AND CROSS-REFERENCE CLAIM

This application claims priority to U.S. Provisional Application No. 60/555,215, filed Mar. 22, 2004.

### FIELD OF INVENTION

The present invention relates to improved composites of fiber-reinforced thermoplastic resins, in particular fiber-reinforced composites that are filled with glass bubbles.

### BACKGROUND

It is known to incorporate fibers into thermoplastic composites to improve the mechanical properties of the thermoplastic material. For example, thermoplastic materials may be reinforced by incorporation of fibers therein to improve the impact strength, tensile strength, tensile and flexural modulus, and resistance to shrinking of the thermoplastic article or member.

It is also known to incorporate hollow particles as fillers into resin compositions to reduce the density of the thermoplastic article or member and to achieve more isotropic coefficient of linear thermal expansion and shrinkage properties as compared to fibers. However, the reduction in density that is achieved by incorporation of hollow particles comes at the cost of reducing desired physical properties of the composite.

A need exists for improved fiber-reinforced thermoplastic composites.

### BRIEF DESCRIPTION OF THE INVENTION

This invention provides fiber-reinforced composites of thermoplastic resins filled with hollow glass microspheres. Composites of the invention provide surprising combinations of lower density and robust physical mechanical properties, e.g., impact resistance, tensile strength, tensile and flexural modulus, reduced shrinkage, and reduced water absorption.

It has been unexpectedly found that the density of fiber-reinforced composites of thermoplastic resins can be significantly reduced by filling with hollow glass bubbles or microspheres substantially without significantly reducing the tensile strength and other physical properties of the composite. As a result, fiber-reinforced thermoplastic composites may be made in lighter yet desirably robust form.

The invention can be used to make composites for use in a variety of structural applications, e.g., as parts for use in motor vehicles.

Briefly summarizing, composites of the invention comprise one or more thermoplastic resins, fiber reinforcing filler, and hollow glass bubbles or microspheres. In some embodiments, the composite will further comprise other additives such as coupling agents or treatments to enhance compatibility of the resin, fibers, bubbles, and other components in the composite, flame retardants, colorants, etc.

Illustrative examples of thermoplastic resins suitable for use in the present invention include polyamides, thermoplastic polyimides (TPI), polyesters, polyolefins, nylons, and blends and copolymers thereof. Illustrative examples include Zytel™ 101L resin from DuPont, a nylon 6,6 resin, and blends of nylon (e.g., NORYL GTX a blend of nylon and polyphenylene ether available from GE).

Many known fiber reinforcing fillers may be used. Illustrative examples of fiber reinforcing fillers suitable for use in the present invention include glass, graphite, Kevlar™ fiber, etc. The filler may be selected dependent in part upon the desired properties of the resultant composite. In some instances, two or more kinds of fillers will be used.

Typically composites of the invention will comprise from about 7 to about 35 weight percent of the fiber-reinforcing filler. Lower amounts may be used but may tend to provide insufficient adjustment of physical properties. Higher amounts may be used but may tend to result in composites that are too highly loaded.

The fiber-reinforcing filler may be surface treated to improve compatibility with the resin matrix. For example, a silane coupling agent or titanate coupling agent, e.g., aminosilanes such as aminopropyltriethoxysilane (“APS”) or N-2-(aminoethyl)-3-amino propyltrimethoxysilane, may be used. Commercially available fiber-reinforcing fillers typically come with coupling agents on them.

Many known hollow microspheres or bubbles, typically preferably glass, may be used. To improve survival of the bubbles during processing of the composite so as to achieve the desired reduction in density, it is typically preferred to use high strength glass bubbles.

In some instances, the vast majority of the bubbles should exhibit an isotactic crush strength of at least 3,000 PSI, preferably higher than 10,000 PSI, to withstand thermoplastic compounding and extrusion operations. In some embodiments, they will preferably exhibit high survivability when exposed to an isotactic crush strength of at least 18,000 PSI to withstand palletizing and injection molding as well as compounding and extrusion operations. The strength of the glass bubbles is typically measured using ASTM D3102-72; “Hydrostatic Collapse Strength of Hollow Glass Microspheres”. An illustrative example of such glass bubbles is 3M™ Scotchlite™ S60HS Glass Bubbles which are soda-lime-borosilicate glass and exhibit an isostatic crush strength of 18,000 psi, density of 0.60 g/cc, and average diameter of about 30 microns.

Typically composites of the invention will comprise from about 5 to about 20 weight percent of the bubbles. Lower amounts may be used if desired but would provide only more limited reduction in density. Higher amounts may be used but may tend to result in composites that are too highly loaded.

Although the bubbles may be surface treated with a coupling agent to improve compatibility with the resin matrix if desired, it has been surprisingly found that such treatments do not provide a significant change in properties, contrary to what is observed when bubbles are incorporated in resin matrices that are not fiber-reinforced.

Articles can be made with composites of the invention by injection molding, extrusion, and other known methods for forming articles from thermoplastic polymers.

Some examples for the utility of lightweight parts with good tensile properties will include sporting goods for reduced user fatigue and/or increases in performance, transportation (automotive, aerospace, etc.) parts for fuel savings, improved acceleration or higher top speed, and reduced fuel emissions.

### EXAMPLES

| Designator | Formula, Structure and/or Name | Availability |
|---|---|---|
| Nylon 66 | ZYTEL ™ 101L: melt index of 60 g/10 m @ | DuPont, |
| | 275° C., T_{g} of 50° C., Tₘ of 260-262° C., and | Wilmington, DE |
| | density of 1.14 g/cm³ | |
| GF | Glass fiber: PPG ™ 3540, density of 2.65 g/cm³ | PPG Industries, |
| | | Shelby, NC |
| GM | Glass Bubbles: SCOTCHLITE ™ S60HS, | 3M Company, St. Paul, |
| | density of 0.6 g/cm³, 18,000 psi (124.0 Mpa) | MN |
| | 10% collapse strength | |
| AEAPTMS | A-1120: N-2-(aminoethyl)-3- | OSI Specialties, |
| | aminopropyltrimethoxy silane | Wilton, CN |
| APTES | A-1100: Aminopropyltriethoxy silane | OSI Specialties |
| Fumed Silica | | Cabot Corporation, |
| | | Alpharetta, GA |
| | | or J. M. Huber, |
| | | Edison, NJ |

Surface Treatment

Where specified, the glass bubbles were washed with deionized water and dried prior to surface treatment. After the washing, fumed silica (up to 2% by weight) was admixed with the glass microspheres. The silane treatment (APTES or AEAPTMS) was dissolved in water (0.2 to 0.5% by weight). The ensuing solution (1500 g) was charged to a Ross Mixer (available from Charles Ross & Son Company, Hauppauge, N.Y.). The mixing was then initiated at medium speed and glass microspheres (GM) were slowly added. Upon completion of GM addition, the mixture was allowed to continue mixing for an additional 15 minutes. The resulting wet GM paste was then poured into aluminum pans and dried in an oven at 80° C. After drying, the microspheres were screened through a 180 micron sieve. Typically the yield of treated GM was greater than 90%.

Compounding and Molding of Composites

All samples were compounded on a Berstorff Ultra Glide twin screw extruder (TSE; 25 mm screw diameter; Length to Diameter ratio of 36:1; available from Berstorff GmbH, Hannover, Germany) equipped with top feeders for microspheres and glass fibers, a water bath and pelletizer accessories. Screw speed ranged from 140 to 160 rpm. Temperature set points range from 200° F. to 575° F. (93° C. to 302° C.), while the actual values range from 500° F. to 575° F. (93° C. to 260° C.). TSE throughput was about 10 lbs/hr.

Test specimens were then molded on a 150 ton Engel Injection Molding Machine (available from ENGEL GmbH, Schwertberg, Austria) using an ASTM four cavity mold. The screw diameter used was 30 mm and the injection pressure was maintained below 18,000 psi (124 Mpa) to minimize microsphere breakage.

Test Methods

Tensile Modulus
Tensile Modulus was determined following ASTM Test Method D-638 and is reported in Mpa.
Ultimate Tensile Modulus
Ultimate Tensile Modulus was determined following ASTM Test Method D-638 and is reported in Mpa.
Flexural Modulus
Flexural Modulus was determined following ASTM Test Method D-790 and is reported in Mpa.
Ultimate Flexural Strength
Ultimate Flexural Strength was determined following ASTM Test Method D-790 and is reported in Mpa.
Elongation at Break
Elongation at Break was determined following ASTM Test Method D-638 and is reported as %.
   Density

A fully automated gas displacement pycnometer obtained under the trade designation “ACCUPYC 1330 PYCNOMETER” from Micromeritics, Norcross, Ga., was used to determine the density of the injection molded composite material according to ASTM D-2840-69, “Average True Particle Density of Hollow Microspheres”.

Physical Measurement Procedures

The densities of the injected molded composite samples were measured using a Micromeretics Accupyc 1330 Helium Pycnometer (available from Micromeritics Instrument Corporation, Norcross, Ga.). Mechanical and thermal properties of the injection-molded composites were measured using ATSTM standard test methods listed in Table 1.

TABLE 1

| Test | Designator | ASTM # |
|---|---|---|
| Tensile Modulus (Mpa) | TM | D-638 |
| Ultimate Tensile Strength (Mpa) | TS | D-638 |
| Flexural Modulus (Mpa) | FM | D-790 |
| Ultimate Flexural Strength (Mpa) | FS | D-790 |
| Elongation at Break (%) | EL | D-638 |
| Un-notched Izod Impact (J/cm) | UI | D-4812 |
| Notched Izod Impact (J/cm) | NI | D-256 |

A variety of composites were prepared with the compositions indicated in Table 2.

TABLE 2

| | | | | | Molded part |
|---|---|---|---|---|---|
| | Silane | | GF | Nylon | Density |
| Example | (% added) | GM (wt %) | (wt %) | (wt %) | (g/cm³) |
| C-1 | None added | 0 | 33 | 67 | 1.39 |
| 1 | None added | 5 | 31 | 64 | 1.34 |
| 2 | None added | 10 | 30 | 60 | 1.29 |
| 3 | None added | 15 | 28 | 57 | 1.24 |
| 4 | None added | 20 | 26 | 54 | 1.19 |
| 5* | AEAPTMS | 5 | 31 | 64 | 1.33 |
| | (0.5) | | | | |
| 6* | AEAPTMS | 10 | 30 | 60 | 1.27 |
| | (0.35) | | | | |
| 7* | AEAPTMS | 15 | 28 | 57 | 1.22 |
| | (0.5) | | | | |
| 8* | AEAPTMS | 20 | 26 | 54 | 1.17 |
| | (0.5) | | | | |
| C-2 | None added | 0 | 20 | 80 | 1.27 |
| 9 | None added | 5 | 19 | 76 | 1.22 |
| 10 | None added | 10 | 18 | 72 | 1.18 |
| 11 | None added | 15 | 17 | 68 | 1.14 |
| 12 | None added | 20 | 16 | 64 | 1.10 |
| 13* | APTES | 5 | 19 | 76 | 1.23 |
| | (0.5) | | | | |
| 14 | APTES | 10 | 18 | 72 | 1.17 |
| | (0.35) | | | | |
| 15 | AEAPTMS | 15 | 17 | 68 | 1.14 |
| | (0.5) | | | | |
| 16 | AEAPTMS | 20 | 16 | 64 | 1.08 |
| | (0.5) | | | | |
| C-3 | None added | 0 | 10 | 90 | 1.20 |
| 17 | None added | 5 | 10 | 85 | 1.16 |
| 18 | None added | 10 | 9 | 81 | 1.11 |
| 19 | None added | 15 | 8 | 77 | 1.07 |
| 20 | None added | 20 | 8 | 72 | 1.03 |
| 21 | AEAPTMS | 5 | 10 | 85 | 1.15 |
| | (0.5) | | | | |
| 22 | AEAPTMS | 10 | 9 | 81 | 1.11 |
| | (0.5) | | | | |
| 23 | AEAPTMS | 15 | 8 | 77 | 1.07 |
| | (0.5) | | | | |
| 24 | AEAPTMS | 20 | 8 | 72 | 1.03 |
| | (0.5) | | | | |

*GMs were washed as described above

The composites were evaluated in accordance with the procedures indicated above to yield the results tabulated in Table 3.

TABLE 3

| Exam- | TS | TM | EL | FS | FM | UI | NI |
|---|---|---|---|---|---|---|---|
| ple | (Mpa) | (Mpa) | (%) | (Mpa) | (Mpa) | (J/cm) | (J/cm) |
| C-1 | 187 | 2567 | 8.9 | 280 | 9266 | 6.3 | 1.1 |
| 1 | 178 | 3135 | 8.7 | 260 | 9607 | 7.0 | 1.4 |
| 2 | 179 | 3240 | 9.4 | 239 | 9000 | 7.4 | 0.9 |
| 3 | 149 | 3156 | 7.7 | 226 | 9786 | 6.8 | 1.1 |
| 4 | 145 | 3230 | 7.6 | 203 | 9545 | 5.8 | 1.1 |
| 5* | 192 | 2672 | 9.2 | 272 | 9223 | 7.2 | 1.2 |
| 6* | 183 | 3256 | 9.4 | 254 | 8875 | 7.5 | 0.9 |
| 7* | 178 | 2834 | 8.8 | 246 | 8955 | 6.3 | 0.8 |
| 8* | 166 | 3141 | 8.9 | 235 | 8971 | 5.9 | 1.1 |
| C-2 | 117 | 3175 | 7.0 | 196 | 6060 | 3.9 | 0.8 |
| 9 | 98 | 2401 | 6.3 | 189 | 6393 | 4.3 | 0.9 |
| 10 | 131 | 2993 | 8.8 | 184 | 6244 | 4.0 | 0.5 |
| 11 | 117 | 2617 | 7.1 | 174 | 6868 | 4.2 | 0.9 |
| 12 | 111 | 2553 | 6.9 | 160 | 6965 | 4.5 | 0.8 |
| 13* | 126 | 2393 | 7.3 | 214 | 6693 | 4.3 | 1.1 |
| 14 | 136 | 2715 | 8.3 | 207 | 6261 | 3.7 | 0.5 |
| 15 | 127 | 3532 | 7.4 | 196 | 6371 | 3.5 | 0.9 |
| 16 | 129 | 2528 | 7.8 | 199 | 6864 | 3.9 | 0.7 |
| C-3 | 78 | 1727 | 6.2 | 147 | 4495 | 2.8 | 0.6 |
| 17 | 84 | 1861 | 6.5 | 140 | 4428 | 2.5 | 0.7 |
| 18 | 83 | 1998 | 6.3 | 136 | 4706 | 2.5 | 0.6 |
| 19 | 76 | 2035 | 5.8 | 128 | 4800 | 2.3 | 0.6 |
| 20 | 79 | 2163 | 6.0 | 116 | 4997 | 2.4 | 0.4 |
| 21 | 76 | 1885 | 5.9 | 139 | 4323 | 2.6 | 0.6 |
| 22 | 82 | 1933 | 6.2 | 153 | 4652 | 2.7 | 0.6 |
| 23 | 85 | 2049 | 6.1 | 156 | 4955 | 2.8 | 0.6 |
| 24 | 96 | 2101 | 7.0 | 158 | 5047 | 2.5 | 0.6 |

*GMs were washed as described above

1. A composite comprising one or more thermoplastic resins, one or more fiber-reinforcing fillers, and hollow microspheres.

2. The composite of claim 1 wherein said resin is selected from the group of polyamides, thermoplastic polyimides (TPI), polyesters, polyolefins, nylons, and blends and copolymers thereof.

3. The composite of claim 1 wherein said fiber reinforcing fillers are selected from the group of glass, graphite, and Kevlar™ fiber.

4. The composite of claim 1 wherein said composite comprises from 7 to 35 weight percent of said fiber-reinforcing filler.

5. The composite of claim 1 wherein said microspheres are glass bubbles.

6. The composite of claim 1 wherein said composite comprise from 5 to 20 weight percent of said bubbles.
